(19) United States
(12) Patent Application Publication
(10) Pub. No.: US 2023/0094105 A1
(43) Pub. Date: Mar. 30, 2023

(54) ORGANOMETALLIC GELS

(71) Applicant: University of York, York (GB)

(72) Inventors: David Smith, York (GB); Peter O'Brien, York (GB); Peter Slavik, York (GB)

(21) Appl. No.: 17/919,913

(22) PCT Filed: Apr. 20, 2021
(86) PCT No.: PCT/GB2021/050950

§ 371 Date: Oct. 19, 2022

(30) Foreign Application Priority Data
Apr. 20, 2020 (GB) 2005726.1

(51) Int. Cl. B01J 13/00

(52) U.S. Cl. CPC B01J 13/0065

(57) ABSTRACT

This invention relates to gels encapsulating organometallic reagents, particularly organolithium reagents. The invention also relates to methods of making said gels and methods of using said gels. The gels are particularly useful in organic synthesis being easier to handle than the organometallic reagent solutions typically used.

This invention relates to gels encapsulating organometallic reagents. The invention also relates to methods of making said gels and methods of using said gels. The gels are particularly useful in organic synthesis.

### BACKGROUND

Organometallic reagents, e.g. organolithium reagents, are a vital tool in modern organic chemistry allowing the synthesis of new carbon-carbon bonds. Organometallic reagents are typically sold as solutions in inert solvents in septum sealed bottles.

However, due to the high reactivity of organometallic reagents, the use of low temperatures, inert atmosphere and strictly dried solvents are often necessary. More reactive organometallic agents can present fire risks. The solutions can degrade over time, particularly when small amounts of the solution are repeatedly extracted from the bottle and the septum degrades, allowing air and/or water in that reacts with the organometallic reagent and reducing the concentration of unreacted organometallic reagent.

Buchwald and coworkers have developed capsules comprising a reservoir of reactive palladium precatalysts inside a hollowed out paraffin capsule (Sather, A. C., Lee, H. G., Colombe, J. R., Zhang, A. & Buchwald, S. L. Dosage delivery of sensitive reagents enables glove-box-free synthesis. Nature 524, 208, doi:10.1038/nature14654 (2015)).

However, the capsules can only be used to deliver a quantum of the precatalyst, they cannot be subdivided to allow the addition of an accurate dosing of the reagent into the desired reaction vessel. The process of forming the capsules is also time consuming and would be difficult to scale to quantities appropriate for commercial use.

### BRIEF SUMMARY OF THE DISCLOSURE

In a first aspect of the invention is provided a gel, the gel comprising:
a solid phase comprising an inert gelating agent; and
a liquid phase comprising an inert organic solvent and an organometallic reagent.

The gel is for use in chemical reactions and particularly in organic synthesis. The inventors have found that gels can be formed with encapsulated organometallic agents. These gels are easier to handle than solutions of the organometallic reagents. Many of these gels can be handled in air, avoiding the need for the organometallic reagent to be handled under inert conditions before being added to the reaction mixture. The gels often also have greater longevity than solutions of the same organometallic reagents.

A further benefit of the gels of the invention is that the concentration of the organometallic reagent is substantially homogeneous throughout the gel. This means that a bulk sample of the gel can be subdivided to provide an accurate amount of organometallic reagent for the desired reaction.

A further benefit of the gels of the invention is that the organometallic can be slowly released from the gel into a reaction, e.g. by not stirring the reaction. This would allow the organometallic to diffuse out of the gel into a reaction solvent over time rather than in a single release event. Certain reactions would benefit from such slow addition of the organometallic, e.g. reactions that are strongly exothermic, particularly when carried out on a large scale.

The organometallic reagent can be any reagent in which there is a bond between a carbon atom and a metal atom. Illustrative examples include organolithium reagents, Grignard reagents and organozinc reagents.

The organometallic reagent may be an organolithium reagent. The organolithium reagent may be selected from a C₁-C₂₀-alkyl lithium and a phenyl lithium (the phenyl group of which may be unsubstituted or may be substituted with 1-5 functional groups that are unreactive to organolithium reagents, e.g. alkyl groups, silyl ethers, dialkylamines).

Examples of suitable organolithium reagents include n-butyl lithium, sec-butyl lithium, methyl lithium and phenyl lithium. The organometallic reagent may be selected from n-butyl lithium, methyl lithium and phenyl lithium. The organometallic reagent may be selected from n-butyl lithium and phenyl lithium.

The organometallic reagent may be a Grignard reagent. Grignard reagents are organo magnesium halides. The Grignard reagent may be selected from a C₁-C₂₀-alkyl magnesium halide, a phenyl magnesium halide (the phenyl group of which may be unsubstituted or may be substituted with 1-5 functional groups that are unreactive to Grignard reagents, e.g. alkyl groups, silyl ethers, alkyl ethers, dialkylamines, halogens), a C₂-C₂₀-alkenyl magnesium halide, and a C₂-C₂₀-alkenyl magnesium halide.

Examples of suitable Grignard reagents include phenyl magnesium bromide, phenyl magnesium chloride, vinyl magnesium bromide, methyl magnesium chloride, methyl magnesium chloride. The organometallic reagent may be selected from phenyl magnesium chloride and vinyl magnesium bromide.

The organometallic reagent may be an organozinc reagent. The organozinc reagent may be a dialkyl zinc reagent. Alternatively, the organozinc reagent may be an alkyl zinc halide reagent.

The organometallic may be an organopalladium.

In the context of this specification, the term ‘inert’ means unreactive to the organometallic reagent. Thus the inert gelating agent is a gelating agent that is unreactive to the organometallic reagent. Likewise the inert organic solvent is a solvent that is unreactive to the organometallic reagent.

The gelating agent may be a gelating agent that does not comprise any X¹—H groups, where X¹ is a heteroatom. X′ may be a heteroatom selected from S, N and O. The gelating agent may be a gelating agent that does not comprise any groups selected from: functional groups comprising a carbon-heteroatom (e.g. O, S or N) double bond and halide groups.

The gelating agent is typically an inert supramolecular gelating agent. For example, the gelating agent may be a hydrocarbon or a mixture of hydrocarbons. Such supramolecular gelating agents are easier to remove from a reaction mixture during work-up and purification than other gelating agents (e.g. polymeric gelating agents). Another advantage of supramolecular gelating agents is that the gel can be switched back from high viscosity to low viscosity, for example by application of heat. This thermal reversibility allows the gel to be warmed up and then flowed through liquid handling systems before use or before being set into a gel again.

The gelating agent may be an alkane or a mixture of alkanes. The gelating agent may be a C₂₀-C₅₀ alkane or a mixture of C₂₀-C₅₀ alkanes. The gelating agent may be a C₃₀-C₄₀ alkane or a mixture of C₃₀-C₄₀ alkanes. The gelating agent may comprise hexatriacontane (C₃₆H₇₄). The gelating agent may comprise paraffin wax. The gelating agent may be hexatriacontane (C₃₆H₇₄). The gelating agent may be paraffin wax.

Long-chain alkanes such as those described above form gels with a wide range of organic solvent. The solid phase of these gels comprises a porous network of platelets, each platelet being formed of a plurality of interdigitated molecules of the long-chain alkane. The liquid phase is situated in the pores of the porous network.

The gelating agent may be a steroid that does not comprise any X¹—H groups, where X¹ is a heteroatom.

The organic solvent may be an organic solvent that does not comprise any X²—H groups, where X² is a heteroatom. X² may be a heteroatom selected from S, N and O.

The organic solvent may be an organic solvent that does not comprise any groups selected from: functional groups comprising a carbon-heteroatom (e.g. O, S or N) double bond and halide groups.

The organic solvent may be an alkane, an aromatic solvent or an ether. Illustrative alkanes include hexanes, heptanes and cyclohexane. Illustrative aromatic solvents include toluene. Illustrative ethers include diethyl ether, diisopropyl ether, dibutyl ether, tetrahydrofuran, 2-methyltetrahydrofuran.

Organometallic reagents are typically supplied as standard as solutions in solvents to which the organometallic reagent is unreactive. The skilled person would therefore be aware of the solvents that are unreactive with any given organometallic reagent.

For organolithiums, the solvent may be may be an alkane, an aromatic solvent or an ether. For example, for n-butyl lithium, the organic solvent may be selected from hexanes, heptane, cyclohexane, toluene and a mixture thereof; for phenyl lithium the organic solvent may be selected from dibutyl ether, cyclohexane, diethyl ether and a mixture thereof; for methyl lithium, the organic solvent may be diethyl ether; for sec-butyl lithium the organic solvent may be cyclohexane.

For Grignard reagents or organo zinc halide reagents, the organic solvent may be an ether, e.g. an ether selected from diethyl ether, tetrahydrofuran and 2-methyltetrahydrofuran.

For dialkylzinc reagents the organic solvent may be selected from hexanes, heptane, cyclohexane, toluene and a mixture thereof.

Organometallic reagents are typically supplied as standard at concentrations that can reproducibly provide stable solutions. The skilled person would therefore be aware of appropriate concentrations of any given organometallic in any given standard solvent. The concentration of the organometallic reagent within the liquid phase will typically be in the range 0.25 M to 3 M. Where the organometallic reagent is n-butyl lithium, for example, the concentration of the n-butyl lithium in the liquid phase may be 1.6 M or 2.5 M.

It may be that the gelating agent is present at an amount in the range from 3% wt/vol to 50% wt/vol of the gel. At higher loadings of the gelating agent, the gels become stiffer and this facilitates the subdivision of a block of gel to provide an accurate amount of organometallic for a desired reaction referred to earlier. The loading at which this occurs varies from solvent to solvent. Typically loadings above 15% wt/vol provide suitably stiff gels. For alkanes (e.g. hexanes, heptane), a loading of from 10% wt/vol to 25% wt/vol (e.g. 15-20% wt/vol) is most appropriate. For 2-Me THF, for example, a loading greater than 5% wt/vol provides suitable stiffness.

The loading of the gelating agent at which the gel becomes stiffer may also depend on the nature of the organometallic reagent.

Higher loadings (>25%) may be used for more reactive organometallics, e.g. s-BuLi.

The gel may be in the form of a block of coated gel. The coating may comprise the gelating agent used for the solid phase of the gel. The coating may comprise a C₂₀-C₅₀ alkane or a mixture of C₂₀-C₅₀ alkanes. The coating may comprise a C₃₀-C₄₀ alkane or a mixture of C₃₀-C₄₀ alkanes. The coating may comprise hexatriacontane (C₃₆H₇₄). The coating may comprise paraffin wax.

It may be that the only components of which the gel is comprised are the gelation agent, the organic solvent and the organometallic reagent.

Alternatively, the gel may comprise other additives such as solvent stabilisers or internal standards.

In a second aspect of the invention is provided a method of making a gel of the first aspect, the method comprising:
mixing the gelating agent with a solution of the organometallic reagent in the organic solvent;
heating the mixture; and
cooling the mixture to form a gel of the first aspect.

The mixture will typically be heated to a temperature below the boiling point of the organic solvent.

The gelating agent is typically a solid at ambient temperatures. Before the mixture is heated, therefore, it is typically biphasic. The mixture is heated to increase the dissolution of the gelating agent in the solvent. The product of the heating step is typically a solution of the organometallic agent and the gelating agent in the solvent. It may be however that the product of the heating step is a dispersion of the gelating agent in a solution of the organometallic reagent in the solvent.

The step of cooling the mixture may comprise placing the mixture in a cooler environment, e.g. a cooling bath or a refrigerator. The step of cooling the mixture may comprise allowing the mixture to cool to ambient temperature.

The steps of mixing, heating and cooling the mixture will typically be conducted under an inert atmosphere.

It may be that the process is conducted in a mould to provide, following the cooling step, the gel of the first aspect set in a mould. It maybe that just the cooling step is carried out in a mould. If this is the case, the process further comprises pouring the heated mixture that results from the heating step into the mould. It may be that both the heating step and the cooling step is carried out in a mould. If this is the case, the process further comprises pouring the mixture that results from the mixing step into the mould. In these embodiments, it may be that the process further comprises removing the gel from the mould.

The process may comprise coating a block of the gel, e.g. by dipping the block in a coating agent or by spraying the block with a coating agent. This may be carried out after the gel has been removed from a mould, in embodiments in which the gel is formed in a mould.

The gel of the first aspect of the invention may be obtainable by (e.g. obtained by) the method of the second aspect of the invention.

In a third aspect of the invention is provided a method of performing a step of an organic synthesis, the method comprising: reacting an organic species with the gel of the first aspect.

In a fourth aspect of the invention is provided a use of a gel of the first aspect in a step of an organic synthesis.

Illustrative steps of organic syntheses for which the gels of the invention might be used include: addition of the carbon portion of the organometallic to an electrophilic functional group of an organic molecule functional group, e.g. a functional group selected from an imine, a carbonyl or an epoxide; deprotonation of a 2° amine, e.g. diisopropylamine or hexamethyldisilazine, to form a deprotonating reagent having a negative charge on nitrogen, e.g. lithium diisopropylamide (LDA) or lithium hexamethyldisilazine (LiHMDS), that is itself used to deprotonate an organic molecule, e.g. to remove a proton a to carbonyl group of an organic molecule; to perform a metal-halogen exchange (e.g. a lithium-bromine exchange).

The step will typically comprise mixing the gel of the invention with an organic reaction solvent and at least one organic molecule. The order and rate of addition of the various components, the temperature (or temperatures where the reaction mixture is subjected to different temperatures as appropriate) and atmosphere of the reaction, the relative amounts of the various components will all be selected by the chemist or chemists conducting the reaction based on the desired outcome of the reaction.

The reaction step may be conducted at a higher temperature than would be used for the same reaction using a solution of the organometallic rather than the gel of the invention.

The gel may be handled and added to the reaction flask under ambient conditions. Many of the gels of the invention can be handled without using inert atmosphere handling techniques.

The reaction step may be conducted under ambient conditions.

It may be that the reaction mixture is agitated in such a way that the gel remains intact. This allows the slow addition of the organometallic to the reaction mixture by diffusion.

The method may comprise separating the gelating agent from the reaction mixture by precipitation. Long chain alkanes, for example, can precipitate out of certain reaction solvents at 20° C., e.g. dibutyl ether. Thus, once the reaction is complete, the reaction mixture may be filtered to remove the gelating agent.

Alternatively, the gelating agent may be removed from the reaction mixture by extraction, e.g. using a non-polar solvent depending on the identity of the desired product.

Alternatively, the gelating agent may be removed by chromatography, e.g. by flushing a chromatographic apparatus with a non-polar solvent system.

The gel of the first aspect of the invention used in the third or second aspect of the invention may be obtainable by (e.g. obtained by) the second aspect of the invention.

In a fifth aspect of the invention is provided a use of an inert supramolecular gelating agent to stabilise an organometallic reagent. The various embodiments for gelating agents and organometallic agents presented in relation to the first aspect of the invention elsewhere, apply equally to the fifth aspect of the invention.

The present application and invention further includes the subject matter of the following numbered clauses:

1. A gel, the gel comprising:
a solid phase comprising an inert gelating agent; and
a liquid phase comprising an inert organic solvent and an organometallic reagent.
2. A gel of clause 1, wherein the organometallic reagent is an organolithium reagent.
3. A gel of clause 2, wherein the organolithium reagent is selected from n-butyl lithium, methyl lithium and phenyl lithium.
4. A gel of clause 1, wherein the organometallic reagent is a Grignard reagent.
5. A gel of any one of clauses 1 to 4, wherein the gelating agent is a C₂₀-C₅₀ alkane or a mixture of C₂₀-C₅₀ alkanes.
6. A gel of clause 5, wherein the gelating agent is hexatriacontane (C₃₆H₇₄).
7. A gel of any one of clauses 1 to 6, wherein the organic solvent may be an organic solvent that does not comprise any X²—H groups, where X² is a heteroatom.
8. A gel of clause 7, wherein the organic solvent is selected from hexanes, heptanes, cyclohexane, toluene, diethyl ether, diisopropyl ether, dibutyl ether, tetrahydrofuran and 2-methyltetrahydrofuran.
9. A gel of any one of clauses 1 to 8, wherein the concentration of the organometallic reagent within the liquid phase is in the range 0.25 M to 3 M.
10. A gel of any one of clauses 1 to 9, wherein the gelating agent is present at an amount in the range from 3% wt/vol to 50% wt/vol of the gel.
11. A gel of any one of clauses 1 to 9, wherein the gelating agent is present at an amount in the range from 10% wt/vol to 25% wt/vol of the gel

12. A method of making a gel of any one of clauses 1 to 11, the method comprising:

mixing the gelating agent with a solution of the organometallic reagent in the organic solvent;
heating the mixture; and
cooling the mixture to form a gel of any one of clauses 1 to 11.
13. A method of clause 12, wherein the mixture is heated to a temperature below the boiling point of the organic solvent.
14. A method of clause 12 or clause 13, wherein the steps of mixing, heating and cooling the mixture are conducted under an inert atmosphere.
15. A gel of any one of clauses 1 to 11, wherein the gel is obtainable by the method of any one of clauses 12 to 14.
16. A method of performing a step of an organic synthesis, the method comprising: reacting an organic species with a gel of any one of clauses 1 to 11.
17. A method of clause 16, wherein the reaction mixture is agitated in such a way that the gel remains intact.
18. A use of a gel of any one of clause 1 to 11 in a step of an organic synthesis.

### BRIEF DESCRIPTION OF THE DRAWINGS

Embodiments of the invention are further described hereinafter with reference to the accompanying drawings, in which:

FIG. 1 shows organogels formed using hexatriacontane as a gelating agent: a) T_{gel} values of C₃₆H₇₄ dibutyl ether gels with various concentration of C₃₆H₇₄, inset shows structure of hexatriacontane gelator. b) SEM image of C₃₆H₇₄ hexane gel (10% wt/vol) showing lamellar self-assembly (scale bar 5 μm).

FIG. 2 shows the screening of organolithium gel stability under ambient conditions: a) Determined by ¹H NMR spectroscopy based on relative integrals of the CH₃ group in product and starting material. b) PhLi solution (1.9 M in dibutyl ether) was placed directly into the vial and was stirred under air at room temperature before 2′-methoxyacetophenone 1 was added. c) Vial containing a gel was closed with a lid after 30 min exposure to air.

FIG. 3 shows some nucleophilic addition reactions using organolithium gels in a vial: a) Reaction with 2′-methoxyacetophenone 1. Table footnotes: a Conversion determined by ¹H NMR spectroscopy based on relative integrals of the CH₃ group in product and starting material, b Commercial n-BuLi solution (1.6 M in hexane) was used, c Gel partly dried out, d Vial containing a gel was closed with a lid after 5 min exposure to air. b) Reaction with benzophenone 3—gel was exposed to air for 30 min, conversion in brackets was obtained after 5 min exposure of the gel to air and then closing the vial with a lid and used after 30 min, conversion determined by ¹H NMR spectroscopy. c) Reaction with N-benzylideneaniline 5—gel was exposed to air for 30 min prior to using, conversion determined by ¹H NMR spectroscopy.

FIG. 4 shows PhLi gel blocks: a) Illustrative preparation of PhLi gel block (0.95 mmol). b) Stability of PhLi gel blocks under different storage conditions and subsequent reaction with 2′-methoxyacetophenone 1. The conversion was determined by ¹H NMR spectroscopy based on relative integrals of the CH₃ group in product and starting material. c) PhLi gel block placed in a beaker filled with water. d) PhLi gel block after 30 min in water.

FIG. 5 shows the use of organolithium gel capsules in various organic reactions: a) Addition of organolithium capsules to benzonitrile 7. Yields were determined by ¹H NMR spectroscopy with DMF as an internal standard. b) Synthesis of 870 mg of Orphenadrine 11 using a PhLi gel block (9.5 mmol). c) Bromine-lithium exchange performed using n-BuLi gel capsule. d) Wittig reaction using n-BuLi gel capsule. e) LDA preparation using n-BuLi gel capsule and subsequent reaction with methyl 2-phenylacetate 15. Yields were determined by ¹H NMR spectroscopy with DMF as an internal standard. f) α-C—H bond difunctionalization of pyrrolidine using both PhLi and n-BuLi gel capsules.

### DETAILED DESCRIPTION

Throughout this specification the term inert atmosphere refers to an atmosphere free of water and oxygen. An inert atmosphere will typically be an atmosphere of dry nitrogen or dry argon. Conversely, ‘ambient’ condition means exposed to air, i.e. air that contains water vapour and oxygen.

Throughout this specification, the term ‘supramolecular gelating agent’ refers to a non-polymeric gelating agent that forms the solid phase of a gel in which the individual molecules that form the solid phase associate with one another via non-covalent intramolecular forces, e.g. hydrogen bonds, dipole-dipole interactions, and Van der Waals forces.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

### Examples

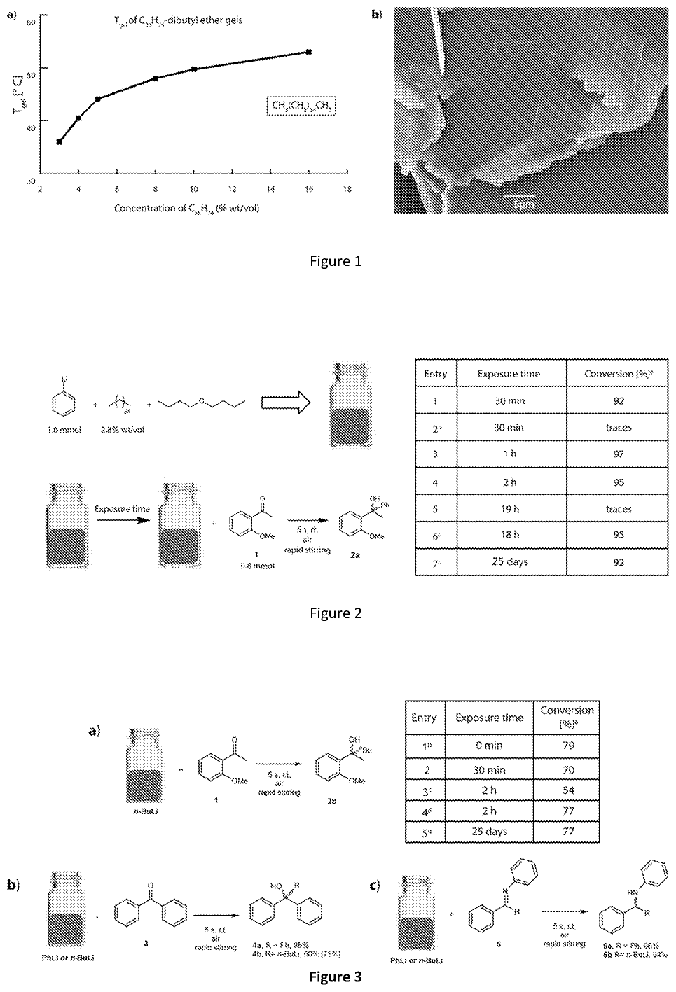

We studied the minimum gelation concentration of C₃₆H₇₄ in dibutyl ether and hexane. These are the solvents most commonly used for the storage of organolithium reagents. In both cases, stable gels were obtained after a heat-cool cycle at concentrations of ca. 3% wt/vol. In addition, the T_{gel} values of these gels were 35-55° C. depending on the concentration of the gelator (FIG. 1a). These relatively low T_{gel} values are desirable for use as organolithium delivery vehicles as they enable easy thermal processing for this class of gels and rapid gel breakdown in the reaction solution (vide infra).

The gels exhibited lamellar platelet-type aggregates (FIG. 1b) when imaged by scanning electron microscopy. In order to prepare an organolithium-loaded gel, a simple procedure combining C₃₆H₇₄ gelator, organolithium reagent (from a commercial solution) and additional solvent was developed. Thus, an oven-dried vial (7 mL, 2 cm diameter, 4.2 cm height) with stirrer bar was charged with the C₃₆H₇₄ gelator, closed with a rubber septum and flushed with nitrogen. Anhydrous, degassed solvent (hexane or dibutyl ether, <50 ppm of H₂O) was added, followed by the organolithium reagent (PhLi in dibutyl ether or n-BuLi in hexane). The vial was carefully heated under a nitrogen atmosphere until all of the gelator had dissolved, and it was then immediately placed in an ice-water bath until the organogel formed. As a result, in each case, we were able to obtain a stable gel with an incorporated organolithium reagent in a vial. Furthermore, based on titration experiments, it was evident that decomposition of the organolithium reagents during the preparation of the gel was negligible.

Encouraged by the successful formation of organolithium gels, we tested their stability and reactivity under ambient conditions. Initially, a gel incorporating PhLi (1.6 mmol, 2 equiv.) and performed a nucleophilic addition reaction with 2′-methoxyacetophenone 1 was used (FIG. 2). In all examples, the gel was exposed to the air for the specified time, after which the neat reagent was placed on the top of the gel in the vial. After rapid stirring for only 5 s, which led to the mechanical breakdown of the gel, the mixture was extracted and analysed by ¹H NMR spectroscopy to determine the conversion to product 2a. As shown in FIG. 2, the gel network provides the incorporated organolithium reagents with significant additional stability in ambient conditions. Exposure of the gel to air at ambient conditions for 30 min and subsequent reaction with 2′-methoxyacetophenone resulted in 92% conversion to 2a (Entry 1). In contrast, when the standard PhLi solution in dibutyl ether was placed in the vial and exposed to ambient air (in a fumehood, 22° C.) for 30 min, only traces of 2a were observed (Entry 2). Prolonging the exposure time of the gel to 2 hours did not cause any significant loss in PhLi activity (Entries 3 and 4). However, overnight exposure resulted in the partial evaporation of the solvent (dibutyl ether) and subsequent damage to the gel network together with the decomposition of PhLi (Entry 5). This drawback could be easily addressed by closing the vial with a lid to prevent evaporation. As a result, a gel that was exposed for 30 min to ambient air and then stored in a closed vial overnight still showed excellent activity: 95% conversion to 2a (Entry 6). Surprisingly, even after a much longer storage time (25 days) under these ambient conditions, the degradation of PhLi inside the gel was still negligible and a 92% conversion to 2a was obtained (Entry 7).

Using a similar approach, a C₃₆H₇₄ gel with incorporated n-BuLi was prepared. The stability and reactivity of this gel under ambient conditions was evaluated by reaction with 2′-methoxyacetophenone 1 (FIG. 3a). The results obtained suggest that the n-BuLi is highly stabilised within the gel and decomposition is limited since the conversion to 2b after 25 days storage under ambient conditions (77%, entry 5) was similar to the reaction using n-BuLi solution (79%, entry 1). A similar reactivity trend was observed for PhLi and n-BuLi organogels using benzophenone 3 or N-benzylideneaniline 5 (FIGS. 3b and 3c).

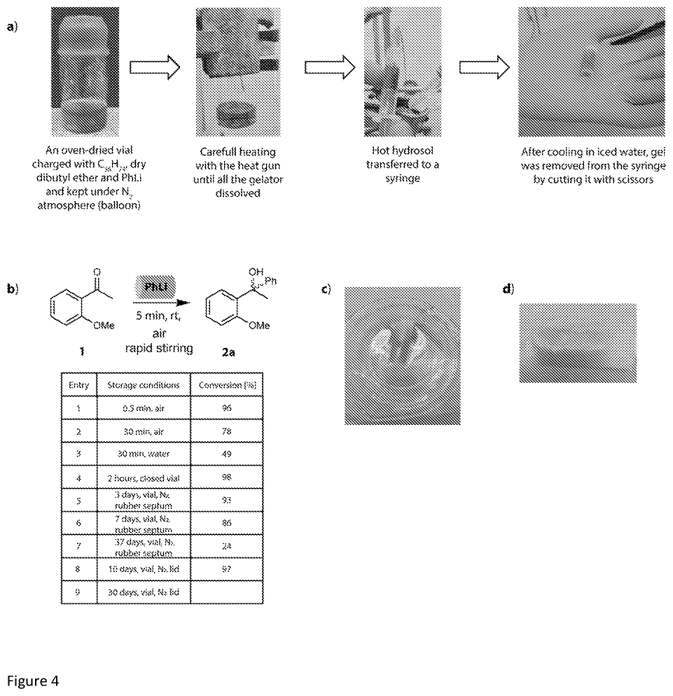

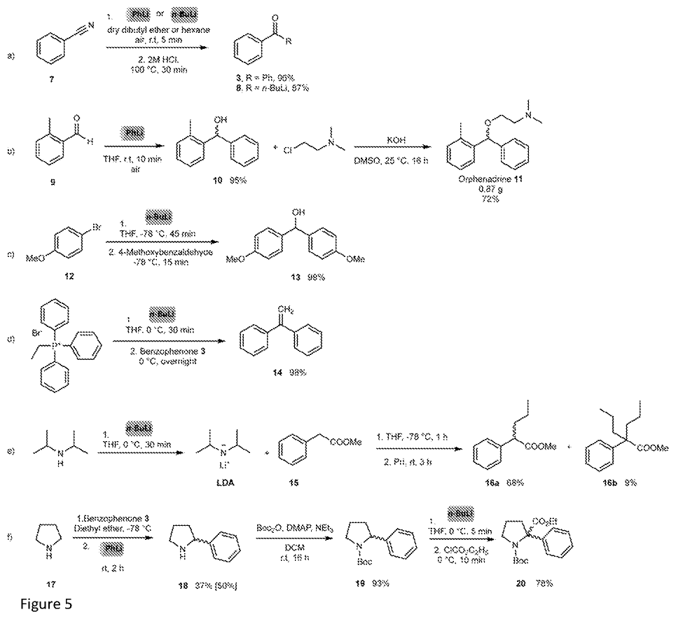

In the synthetic reactions described in detail above, the reagents were placed on the top of the organolithium gel which had been formed within a vial. The obtained results demonstrate that under this experimental set-up the organolithium reagent within the gel is highly stabilised. However, for general and practical use, we wanted to prepare gel ‘blocks’ loaded with a specified amount of organolithium reagent that could be directly and simply transferred to another reaction vessel (such as a round-bottomed flask) containing the other reagents. To achieve this, the original organolithium gel formation procedure was modified enabling us to prepare the gel inside a plastic syringe (FIG. 4a). Increasing the concentration of the C₃₆H₇₄ gelator from 2.8% wt/vol to 16% wt/vol and diluting the PhLi to 0.6 M concentration resulted in the formation of a PhLi gel block that was mechanically stable under ambient conditions and could be easily transferred. It was also possible to incorporate n-BuLi into a gel block using a similar procedure and concentration of the reagents. Other methods for the formation of gel blocks could also easily be envisaged.

With a successful laboratory-scale method for the preparation of gel blocks, we tested their stability and reactivity in a range of nucleophilic addition reactions. The organolithium gel blocks were easily added to the stirred solutions of the reagents under ambient conditions and on breaking the gel block down with stirring, the organolithium reagent was released into the solution. Using organolithium gel blocks of both PhLi and n-BuLi, reactions with 2′-methoxyacetophenone 1 (FIG. 4b), benzophenone 3 or N-benzylideneaniline 5 under ambient conditions proceeded with high conversions (77-98%) even after exposure of the gel blocks to air or prolonged storage. Storage of the gel blocks in an inert atmosphere, by leaving them in the vial closed with a plastic lid, was an effective way of maintaining the activity. After finishing these reactions, the C₃₆H₇₄ gelator was easily removed by filtration and simple flash silica gel chromatography, eluting first with hexane to remove C₃₆H₇₄, and then with 1:1 hexanedichloromethane to obtain the desired product. This was demonstrated for the reaction of PhLi with benzophenone (99% conversion to 4a, 98% isolated yield of 4a.

To further demonstrate the protective ability of the gel network, the PhLi gel block was immersed in a beaker of water for 30 min (FIG. 4c). After that time, the capsule was removed from the water, dried with a paper towel (FIG. 4d) and directly used in a reaction with 2′-methoxyacetophenone 1. The observed conversion to 2a (49%) was lower than the standard reaction. Presumably, PhLi located at the surface of the block partly decomposes upon contact with water. However, the fact that the reaction still proceeds in reasonable yield is evidence of the very high stability of the PhLi that is inside the gel block and the protective effect of encapsulation within the gel. Increasing the loading of the C₃₆H₇₄ gelator to 33% wt/vol and performing the same experiment led to very good conversions of 69%. Clearly, these gel blocks could potentially be further stabilised by coating them with an inert layer, to prevent decomposition at the surface, indeed we demonstrated that coating the gel blocks with paraffin led to ‘filled capsules’ that gave conversions of 84% after exposure to water. However, we reason there are significant advantages of working with gel blocks rather than filled capsules.

Importantly, unlike the ‘drilled-out’ paraffin capsule technology previously reported by Buchwald and co-workers (Sather, A. C., Lee, H. G., Colombe, J. R., Zhang, A. & Buchwald, S. L. Dosage delivery of sensitive reagents enables glove-box-free synthesis. Nature 524, 208, doi:10.1038/nature14654 (2015)), our gel blocks should have an even distribution of reagent through the gel. As a result, this should make it possible to subdivide the storage capsule to facilitate accurate dosing of the organolithium into the desired reaction. In terms of application of the technology, this is important as it demonstrates that a single large batch of gel could be produced ‘in-house’ (or by a chemical supply company), packaged and stored (and shipped) in an appropriate way, and then subdivided into the precise amounts required by the end-user and used in multiple different reactions. To demonstrate the equal distribution of reagent through the gel, a PhLi gel block was carefully cut into three equivalent pieces using a razor blade. Each of these pieces (approx. 2.1 equiv.) was used in a separate reaction with 2′-methoxyacetophenone 1 to give 2a in conversions of 96%, 97% and 98%.

The gel capsules also enable slower release of the organolithium reagent into the reaction mixture as demonstrated by ReactIR experiments. When the commercially available PhLi solution was added, the reaction was immediately complete. On the other hand, when the PhLi gel capsule was added and the mixture was carefully stirred (enabling mixing but not destroying the gel capsule), slow product formation (over 2 hours) was observed, clearly indicating slow release of the PhLi into the reaction mixture. This behaviour could be of particular interest in the reactions where slow or controlled addition of an organometallic reagent is important.

The PhLi and n-BuLi organolithium gel blocks have also been used in other, slightly more challenging reactions (FIG. 5). For example, reaction of the PhLi and n-BuLi organolithium gel blocks with benzonitrile 7 followed by hydrolysis resulted in the formation of ketones 3 and 8 in 96% and 87% yields, respectively (FIG. 5a). We also scaled-up the preparation of the PhLi gel blocks (to 9.5 mmol of PhLi encapsulated, see Example 6) and used this gel in the synthesis of 870 mg of the anticholinergic and antihistamine drug Orphenadrine 11 (FIG. 5b). The first step, the addition of PhLi via a gel block, was performed without the use of any protective inert atmosphere or low temperature, and after alkylation with 2-(N,N-dimethylamino)ethylchloride, Orphenadrine 11 was obtained in 68% yield over the two steps. To show that the organolithium gel blocks are also compatible with other types of reactions, we performed a bromine-lithium exchange reaction with 4-bromoanisole 12 using the n-BuLi gel block at −78° C. under an inert atmosphere followed by trapping the intermediate aryllithium with 4-methoxybenzaldehyde to give alcohol 13 in 99% yield (FIG. 5c). The n-BuLi gel capsule was also successfully used in a Wittig reaction resulting in product 14 formation in 98% yield (FIG. 5d). To show another possible application, we used a n-BuLi gel capsule for the in situ LDA formation and subsequent alkylation reaction of ethyl 2-phenylacetate 15. The successful formation of LDA was proved by absence of the starting material 15 in the reaction mixture after the reaction. Only mono- and di-substituted products 16a and 16b were obtained in 68% and 9% yield, respectively.

Finally, we successfully utilized both the PhLi and n-BuLi gels for a three-step, double α-C—H functionalization of pyrrolidine (FIG. 5d). In the first step, using Seidel's approach with the PhLi gel block, deprotonation of the pyrrolidine 17 by PhLi followed by hydride transfer to Ph₂CO as a hydride acceptor and addition of PhLi to the in situ-generated imine, provided 2-phenylpyrrolidine 18 in 37% yield. 2-Phenylpyrrolidine 18 was then Boc-protected to give compound 19 and then lithiated using a n-BuLi gel block. Subsequent reaction with ethyl chloroformate gave α-disubstituted pyrrolidine 20 in 78% yield.

In summary sensitive organolithium reagents can be successfully incorporated within organogel delivery vehicles. The gel network provides significant stability towards ambient conditions and, as a result, these organolithium gel blocks have the potential to be used without the need for many of the special working protocols usually necessary for this type of chemistry. Our gel-phase approach has several advantages, including solvent compatibility, simple manufacture and even distribution of reagents through the gel for effective subdivision and accurate reaction dosing. The use of gels as simple delivery vehicles for hazardous organometallic reagents has the potential to make these widely-used reactions safer and more accessible, and enabling the more widespread use of these synthetic methods.

### Example 1—General Procedure for the Preparation of the Organolithium Gel in a Vial

A 5 mL vial with stirrer bar was dried in the oven and let to cool under a nitrogen atmosphere. The vial was charged with 80.0 mg (0.16 mmol) of gelator C₃₆H₇₄, closed with a rubber septum and flushed with nitrogen via a needle for 5 min. Anhydrous and degassed solvent (2 mL of dibutyl ether in case of PhLi or 1 mL of hexane in case of n-BuLi) was added through the septum followed by the addition of organolithium reagent (0.84 mL of PhLi or 1 mL of n-BuLi). The vial (kept under nitrogen atmosphere via balloon) was carefully heated until all the gelator dissolved and then was immediately placed in iced water for 1 min until the organogel formed.

### Example 2— Illustrative Method for Use of Organolithium Gel in a Vial in an Organic Reaction: Addition of 2′-Ethoxyacetophenone to PhLi

The PhLi (1.6 mmol) gel was prepared in a vial according to the general procedure of Example 1. The organolithium gel was exposed to air by removing the rubber septum. After the specified time, 2′-methoxyacetophenone 1 (0.8 mmol, 110.4 μL) was added on the top of the gel at room temperature and under air. The mixture was intensively stirred for 5 s before the reaction was quenched by the addition of water (0.5 mL). The organic compounds were extracted with dibutyl ether and dried with magnesium sulphate. Most of the gelator C₃₆H₇₄ was successfully removed during the filtration using glass funnel and filtration paper. The crude reaction mixture obtained after evaporation of the solvent was analysed by ¹H NMR to determine the conversion.

### Example 3—Preparation of the Robust Organolithium Gel

A 5 mL vial with was dried in the oven and let to cool under a nitrogen atmosphere. The vial was charged with 250.0 mg (0.49 mmol) of gelator C₃₆H₇₄, closed with a rubber septum and flushed with nitrogen via a needle for 5 min. Anhydrous and degassed solvent (1 mL of dibutyl ether in case of PhLi or 1 mL of hexane in case of n-BuLi) was added through the septum followed by the addition of organolithium reagent (0.50 mL of PhLi or 0.6 mL of n-BuLi). The vial was carefully heated until all the gelator dissolved. The hot hydrosol was quickly transferred via needle to a 2 mL syringe (previously flushed with inert and pre-heated at the oven) and still kept under the nitrogen atmosphere. The syringe was immediately placed in iced water for 1 min until the organogel formed. The organolithium gel was kept in the syringe under the nitrogen atmosphere prior to use. In order to use the organolithium gel, the upper part of the syringe was carefully cut with scissors and gel was taken away.

### Example 4—Illustrative Method for Use of Robust Organolithium Gel in an Organic Reaction: Addition of Robust n-BuLi Gel to Benzophenone

The n-BuLi (0.96 mmol) gel was prepared according to the general procedure of Example 3. After brief exposure to air (10 s), the gel was carefully placed in a 5 mL round-bottom flask containing benzophenone 3 (0.48 mmol, 0.0875 g) in 2 mL of dry hexane under ambient conditions. The mixture was intensively stirred for 5 min before the reaction was quenched by the addition of water (0.5 mL). The organic compounds were extracted with dibutyl ether and dried with magnesium sulphate. Most of the gelator C₃₆H₇₄ was successfully removed during the filtration using glass funnel and filtration paper. The crude reaction mixture obtained after evaporation of the solvent was analysed by ¹H NMR to determine the conversion. Compound 4b: 75%.

### Example 5—Additional Paraffin Coating of Robust Organolithium Gel

Paraffin wax (mp. 43-95° C.) was melted in a beaker and used to prepare empty paraffin capsule using a glass rod. This capsule was filled with a phenyllithium organogel capsule (made using the general procedure of Example 3 from C₃₆H₇₄—166.7 mg, dry dibutyl ether-0.67 mL, phenyllithium—0.33 mL). The paraffin capsule was sealed with a heated glass rod and quickly immersed in a melted paraffin three times (Figure S43 c and d). After cooling, the gel was immersed in water for 30 min in order to test its stability (not a required step). The gel was then removed from water and carefully dried with a paper towel. Paraffin capsule with phenyllithium gel was used for the reaction with 2′-methoxyacetophenone 1 (0.317 mmol) in 5 mL of dry dibutyl ether as described before (however, using a spatula was necessary to break down the gel). The conversion was 84%.

### Example 6—Scale-Up Procedure for the Preparation of Robust PhLi Gel

A 25 mL round-bottom flask that was dried in the oven and let to cool under a nitrogen atmosphere was charged with 2.5 g (4.9 mmol) of gelator C₃₆H₇₄, closed with a rubber septum and flushed with nitrogen via a needle for 5 min. Anhydrous and degassed dibutyl ether (10 mL) was added through the septum followed by the addition of PhLI (5 mL, 9.5 mmol). The flask was carefully heated until all the gelator dissolved. The hot hydrosol was quickly transferred via needle to 20 mL syringe (previously flushed with inert and pre-heated at the oven) and still kept under the nitrogen atmosphere. The syringe was immediately placed in iced water for 1 min until the organogel formed. The organolithium gel was kept in the syringe under the nitrogen atmosphere prior to use. In order to use the organolithium gel, the upper part of the syringe was carefully cut with scissors and gel was taken away.

### Example 7—General Procedure for the Preparation of the Grignard Gel in a Vial

A 5 mL vial with stirrer bar was dried in the oven and let to cool under a nitrogen atmosphere. The vial was charged with 143 mg (0.28 mmol) of gelator C₃₆H₇₄, closed with a rubber septum and flushed with nitrogen via a needle for 5 min. Then, a solution of vinylmagnesium bromide (1.43 mL, 0.7 M in THF) was added through the septum. The vial (kept under nitrogen atmosphere—balloon) was carefully heated until all the gelator dissolved and then was immediately placed in iced water for 1 min until the organogel formed.

### Example 8— Illustrative Method for Use of Grignard Gel in a Vial in an Organic Reaction: Addition of 2-Ethoxyacetophenone to Vinylmagnesium Bromide

The vinylmagnesium bromide (1.0 mmol) gel was prepared in a vial according to the general procedure of Example 1. The Grignard gel was exposed to air by removing the rubber septum. After the specified time, the gel was carefully put to the 10 mL round-bottom flask containing 2′-methoxyacetophenone 1 (0.5 mmol, 68.9 μL) in 3 mL of dry THF. The mixture was intensively stirred for 5 s before the reaction was quenched by the addition of water (0.5 mL). The organic compounds were extracted with diethyl ether and dried with magnesium sulphate. Most of the gelator C₃₆H₇₄ was successfully removed during the filtration using glass funnel and filtration paper. The crude reaction mixture obtained after evaporation of the solvent was analysed by ¹H NMR to determine the conversion.

When the gel was exposed to air for 3 seconds, a conversion of 99% was obtained. When the gel was exposed to air for 5 minutes, a conversion of 88% was obtained.

### Example 9—General Procedure for the Preparation of the PhMgCl Gel in a Vial

A 5 mL vial with stirrer bar was dried in the oven and let to cool under a nitrogen atmosphere. The vial was charged with 100 mg (0.20 mmol) of gelator C₃₆H₇₄, closed with a rubber septum and flushed with nitrogen via a needle for 5 min. Then, a solution of phenylmagnesium chloride (1.5 mL, 1 M in 2-MeTHF) was added through the septum. The vial (kept under nitrogen atmosphere—balloon) was carefully heated until all the gelator dissolved and then was immediately placed in iced water for 1 min until the organogel formed.

Similarly, PhMgCl gels with different wt/vol loading of the gelating agent (10%, 8.3%, 6.7%, 5.7% and 5%) were prepared. All of them were robust enough to transfer them into another reaction vessel.

1. A gel, the gel comprising:
a solid phase comprising an inert supramolecular gelating agent; and
a liquid phase comprising an inert organic solvent and an organometallic reagent.

2. A gel of claim 1, wherein the organometallic reagent is an organolithium reagent.

3. A gel of claim 2, wherein the organolithium reagent is selected from n-butyl lithium, methyl lithium and phenyl lithium.

4. A gel of claim 1, wherein the organometallic reagent is a Grignard reagent.

5. A gel according to claim 1, wherein the gelating agent is a C20-C50 alkane or a mixture of C20-C50 alkanes.

6. A gel of claim 5, wherein the gelating agent is hexatriacontane (C36H74).

7. A gel according to claim 1, wherein the organic solvent may be an organic solvent that does not comprise any X2-H groups, where X2 is a heteroatom.

8. A gel of claim 7, wherein the organic solvent is selected from hexanes, heptanes, cyclohexane, toluene, diethyl ether, diisopropyl ether, dibutyl ether, tetrahydrofuran and 2-methyltetrahydrofuran.

9. A gel according to claim 1, wherein the concentration of the organometallic reagent within the liquid phase is in the range 0.25 M to 3 M.

10. A gel according to claim 1, wherein the gelating agent is present at an amount in the range from 3% wt/vol to 50% wt/vol of the gel.

11. A gel according to claim 1, wherein the gelating agent is present at an amount in the range from 10% wt/vol to 25% wt/vol of the gel.

12. A method of making a gel according to claim 1, the method comprising:
mixing the gelating agent with a solution of the organometallic reagent in the organic solvent;
heating the mixture; and
cooling the mixture to form the gel.

13. A method of claim 12, wherein the mixture is heated to a temperature below the boiling point of the organic solvent.

14. A method of claim 12, wherein the steps of mixing, heating and cooling
the mixture are conducted under an inert atmosphere.

15. A gel comprising:
a solid phase comprising an inert supramolecular gelating agent; and
a liquid phase comprising an inert organic solvent and an organometallic reagent, wherein the gel is obtainable by the method of claim 14.

16. A method of performing a step of an organic synthesis, the method comprising:
reacting an organic species with a gel as in claim 1.

17. A method of claim 16, wherein the reaction mixture is agitated in such a way that the gel remains intact.

18. A use of a gel of claim 1 in a step of an organic synthesis.

19. A use of an inert supramolecular gelating agent to stabilise an organometallic reagent.
